(19) United States
(12) Patent Application Publication
(10) Pub. No.: US 2025/0173174 A1
(43) Pub. Date: May 29, 2025

(54) COMMUNICATION SYSTEM, SWITCHING METHOD, AND SWITCHING PROGRAM

(71) Applicant: NIPPON TELEGRAPH AND TELEPHONE CORPORATION, Tokyo (JP)

(72) Inventors: Hiroki KANO, Tokyo (JP); Shinya KAWANO, Tokyo (JP); Katsuma MIYAMOTO, Tokyo (JP); Koji SUGISONO, Tokyo (JP)

(73) Assignee: NIPPON TELEGRAPH AND TELEPHONE CORPORATION, Tokyo (JP)

(21) Appl. No.: 18/841,372

(22) PCT Filed: Feb. 28, 2022
(86) PCT No.: PCT/JP2022/008309

§ 371 Date: Aug. 24, 2024

(51) Int. Cl. G06F 9/455

(52) U.S. Cl. CPC G06F 9/45558; G06F 2009/45595

(57) ABSTRACT

When a time period set in a timetable in which an FPGA 111 processes a packet is reached, a server switches an NIC that accepts a packet to the FPGA-equipped NIC 11. In addition, even in a time period (a time period in which a CPU processes a packet) other than the time period in which the FPGA 111 processes a packet, the server switches an NIC that accepts a packet to an FPGA-equipped NIC in a case where a power consumption amount of the server exceeds the predetermined threshold or in a case where a load of packet processing in a vGW connected to an NIC 12 exceeds a predetermined threshold.

### TECHNICAL FIELD

The present invention relates to a communication system, a switching method, and a switching program.

### BACKGROUND ART

In the related art, there is a technology (network function virtualization (NFV)) that implements a function of a network device as a virtual machine (VM) on a virtualization infrastructure of a general-purpose server. Since the NEV technology can aggregate physical devices, equipment costs can be reduced.

In the NEV technology, a server operates a VM by using a CPU and processes a packet of a network, but processing performance of the CPU is limited. Therefore, increase in traffic amount results in a plurality of servers having to be provided, thus, increasing equipment costs and power consumption.

In order to solve the above-described problem, a technology has been proposed in which an NIC equipped with a field programmable gate array (FPGA) is connected to a server, and packet processing executed by a CPU is offloaded on the hardware (FPGA).

### CITATION LIST

### Non Patent Literature

Non Patent Literature 1: Intel Corporation FPGA PAC N3000 (Intel FPGA Programmable Acceleration Card N3000), [online], [retrieved on Feb. 15, 2022], Internet <URL: https://www.intel.co.jp/content/www/jp/ja/products/details/fpga/platforms/pac/n3000.html>

### SUMMARY OF INVENTION

### Technical Problem

Since power consumption of the above-described FPGA is constant regardless of a magnitude of a processing load, the FPGA has a problem in that the power efficiency of a server is poor in a situation where the processing load is low. For example, as illustrated in FIG. 1, in a case where a traffic amount to be processed by a server is small, a problem arises in that power consumption becomes larger when the packet is processed by the FPGA than when the packet is processed by the CPU.

Here, for example, as illustrated in FIG. 2, in a case where the traffic amount to be processed by the server significantly fluctuates with time, a problem arises in that power efficiency is not good when the server processes the packet by the FPGA in both of a time period in which the traffic amount is large (a time period represented by reference numeral 201) and a time period in which the traffic amount is small (a time period represented by reference numeral 202).

In order to solve the above problem, for example, a method of providing a server including a network interface card (NIC) equipped with an FPGA, causing the FPGA to process a packet in a time period when a traffic amount is large, and causing the CPU to process a packet in a time period when the traffic amount is small, on the basis of a timetable illustrated in FIG. 3.

However, for example, when the traffic amount unexpectedly increases in the time period in which the server determines that the CPU executes packet processing, the CPU needs to process a large amount of traffic. As a result, there is also a possibility that power efficiency of the server can be reduced, and a communication quality provided by the server can reduced, or the system can be down.

Therefore, the present invention prevents a decrease in power efficiency and a decrease in communication quality from occurring even in a case where an unexpected increase in traffic amount or an unexpected increase in processing load occurs in a time period in which the server performs processing by the CPU.

### Solution to Problem

In order to solve the above-described problem, the present invention includes: a first network interface card (NIC) that is connected to a virtual machine and is equipped with a field programmable gate array (FPGA) which processes an input packet destined for the virtual machine; a second NIC to which the same IP address as an IP address of the virtual machine is set and which is connected to a virtual machine that processes an input packet; and a switching unit that switches an NIC that accepts the input packet; and a controller that instructs the switching unit to switch an NIC that accepts the packet to the first NIC when a predetermined time period in which the FPGA processes a packet is reached and when a power consumption amount of a device equipped with the second NIC exceeds a predetermined threshold or when a load of packet processing in a virtual machine connected to the second NIC exceeds a predetermined threshold, in a time period in which the virtual machine processes a packet.

### Advantageous Effects of Invention

According to the present invention, it is possible to prevent a decrease in power efficiency and a decrease in communication quality from occurring even in a case where an unexpected increase in traffic amount or an unexpected increase in processing load occurs in a time period in which a server performs processing by the CPU.

### BRIEF DESCRIPTION OF DRAWINGS

FIG. 1 is a graph illustrating an example of power consumption of a CPU and an FPGA with respect to a traffic amount.

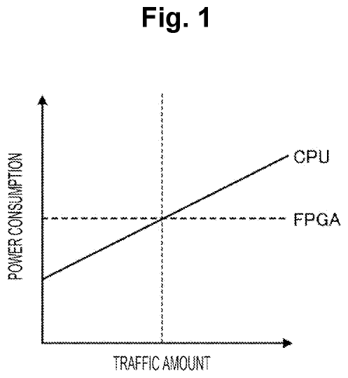

FIG. 2 is a graph illustrating an example of a change in traffic amount for each time point.

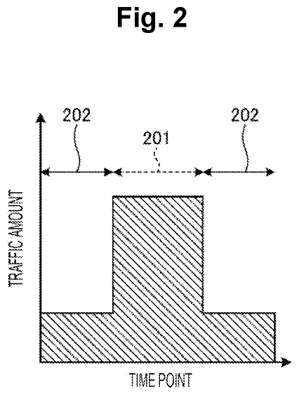

FIG. 3 is a diagram illustrating an example of a timetable used by a server and an example of a change in traffic amount to be processed by the server for each time.

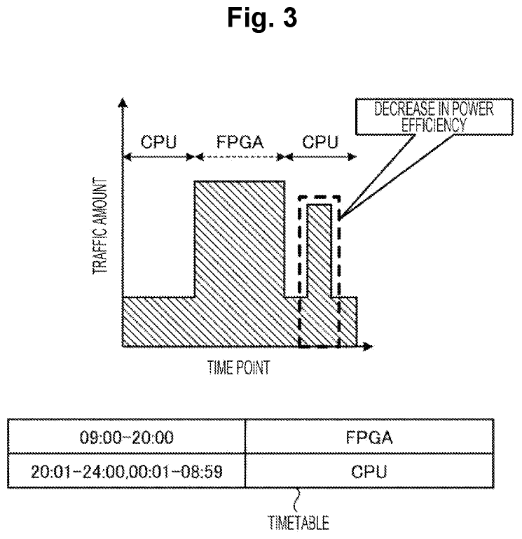

FIG. 4 is a diagram illustrating a configuration example of the server.

FIG. 5 is a diagram illustrating an outline of a processing procedure of the server.

FIG. 6 is a diagram for describing an outline of the server.

FIG. 7 is a diagram illustrating an example of a path of user traffic in a case where the server processes a packet by a CPU.

FIG. 8 is a flowchart illustrating an example of a procedure in which the server determines which of an FPGA and a CPU should process a packet.

FIG. 9 is a flowchart illustrating an example of a processing procedure in a case where the server performs switching such that packet processing performed by the FPGA is performed by the CPU.

FIG. 10 is a flowchart illustrating an example of a processing procedure in a case where the server performs switching such that the packet processing performed by the CPU is performed by the FPGA.

FIG. 11 is a diagram for describing the FPGA of the server.

FIG. 12 is a diagram illustrating a configuration example of a computer that executes a switching program.

### DESCRIPTION OF EMBODIMENTS

Hereinafter, modes for carrying out the present invention (embodiments) will be described with reference to the drawings. The present invention is not limited to the present embodiments.

### [Outline]

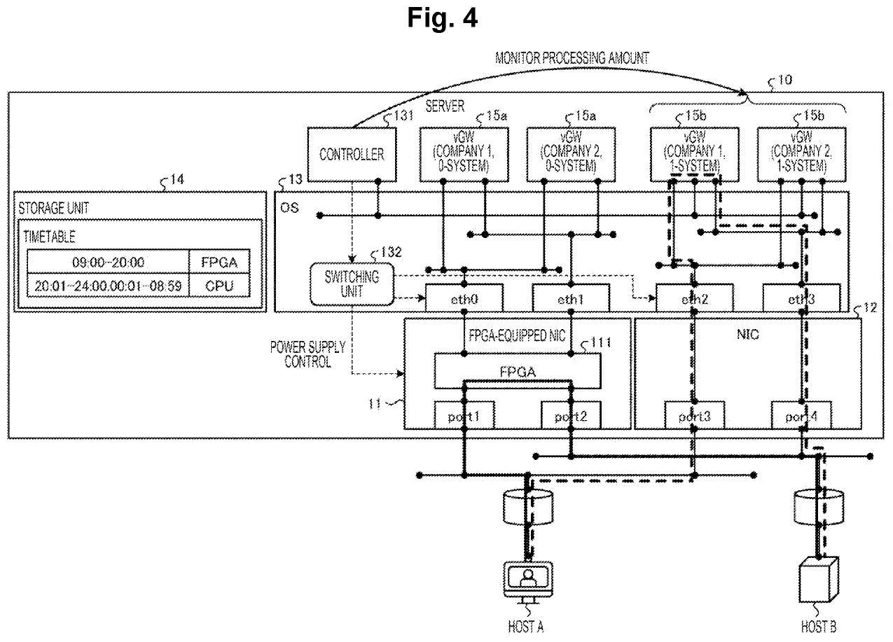

First, an outline of a server 10 of the present embodiment will be described with reference to FIGS. 4 to 6. As illustrated in FIG. 4, the server 10 includes a network interface card (NIC) (FPGA-equipped NIC, first NIC) 11 that is equipped with an FPGA 111 and a normal NIC (second NIC) 12.

A virtual machine (for example, vGW (virtual gateway) 15) having a redundancy configuration is connected to the FPGA-equipped NIC 11 and the NIC 12. Here, among vGWs 15 having the redundancy configuration, a 0-system vGW 15 is referred to as a vGW 15a, and a 1-system vGW 15 is referred to as a vGW 15b. For example, in a case where the 0-system vGW 15a of Company 1 becomes unable to communicate, the 1-system vGW 15b of Company 1 is operated instead of the vGW 15a and processes an input packet. For example, the 0-system vGW 15a is connected to the FPGA-equipped NIC 11, and the 1-system vGW 15b is connected to the NIC 12.

A controller 131 manages, based on a timetable of a storage unit 14, whether a time period is a time period in which the server 10 should process the packet by the FPGA 111 or a time period in which the packet should by processed by the CPU (VGW 15b). In this timetable, as illustrated in FIG. 4, the time period in which the server 10 should process the packet by the FPGA 111 and the time period in which the CPU should process the packet are set. Note that the time period in which the packet should be processed by the FPGA 111 is, for example, a time period in which a traffic amount is relatively large and power efficiency is better when the server 10 processes the packet by the FPGA 111. In addition, the time period in which the CPU should process the packet is, for example, a time period in which a traffic amount is relatively small and power efficiency is better when the server 10 processes the packet by the CPU.

Accordingly, the controller 131 issues, on the basis of the timetable, an instruction indicating that the packet should be processed by the FPGA 111, to the switching unit 132, when the time period in which the packet should be processed by the FPGA 111 is reached. In addition, the controller 131 outputs an instruction indicating that the packet should be processed by the CPU, to the switching unit 132, when the time period in which the packet should be processed by the CPU is reached on the basis of the timetable.

Here, in a case where a power consumption amount of the server 10 and a processing amount of each vGW 15 are large even in a time period in which the packet should be processed by the CPU, the controller 131 instructs the switching unit 132 to cause the FPGA 111 to process the packet.

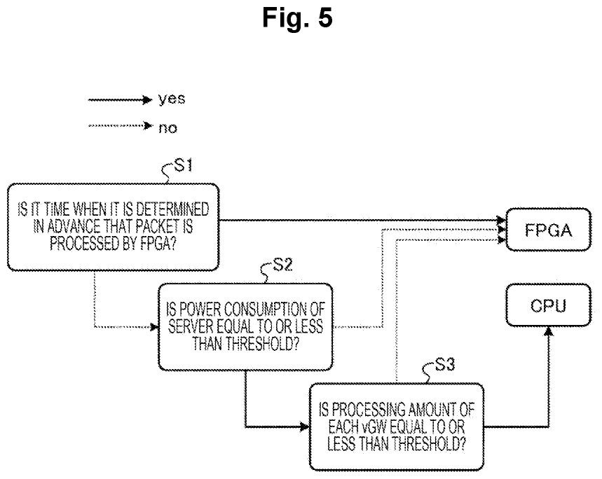

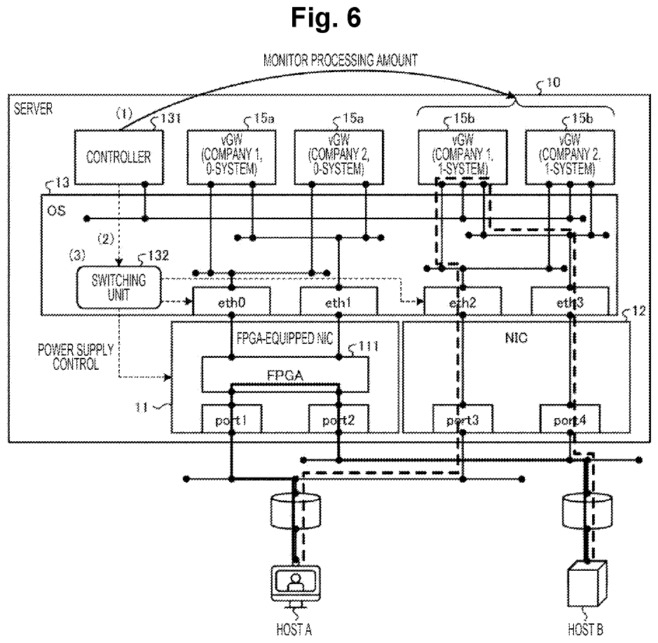

For example, as illustrated in FIG. 6, the controller 131 monitors the processing amount of each 1-system vGW 15b and acquires the power consumption of the server 10. Accordingly, in a case where a time when it is determined in advance that the packet is processed by the FPGA 111 is reached (Yes in S1 in FIG. 5), the controller 131 instructs the switching unit 132 to process the packet by the FPGA 111. On the other hand, the controller 131 instructs the switching unit 132 to perform switching such that packet processing is performed by the FPGA 111 when the power consumption of the server 10 exceeds the threshold (No in S2) even when a time is other than the time when it is determined in advance that the packet is processed by the FPGA 111 (that is, the time when the packet should be processed by the CPU) (No in S1).

In addition, even in a case where the power consumption of the server 10 is equal to or smaller than the threshold (Yes in S2), the controller 131 instructs the switching unit 132 to perform switching such that the packet processing is performed by the FPGA 111 in a case where the processing amount of each vGW 15 (vGW 15b) exceeds the threshold (No in S3).

Note that the controller 131 causes the CPU of the server 10 to process the packet when the power consumption of the server 10 is equal to or smaller than the predetermined threshold, and the processing amount of each VGW 15 is equal to or smaller than the threshold (No in S1→Yes in S2→Yes in S3), in a time other than the time when it is determined in advance that the packet is processed by the FPGA 111 (that is, time when it is determined in advance that the packet is processed by the CPU).

In this manner, in a case where an unexpected increase in traffic amount or an unexpected increase in processing load occurs in a time period in which it is determined in advance that the packet is processed by the CPU, the controller 131 can perform switching such that the packet is processed by the FPGA 111.

The switching unit 132 executes switching between NICs on the basis of the instruction from the controller 131. For example, when the switching unit 132 receives, from the controller 131, an instruction indicating that the packet should be processed by the FPGA-equipped NIC 11, a power supply of the FPGA-equipped NIC 11 is turned on. Consequently, since a vGW 15 corresponding to a VIP (virtual IP address) becomes the vGW 15a, a packet destined for the VIP is input to the FPGA-equipped NIC 11 and processed by the FPGA 111 (see a path represented by the thick line in FIG. 6).

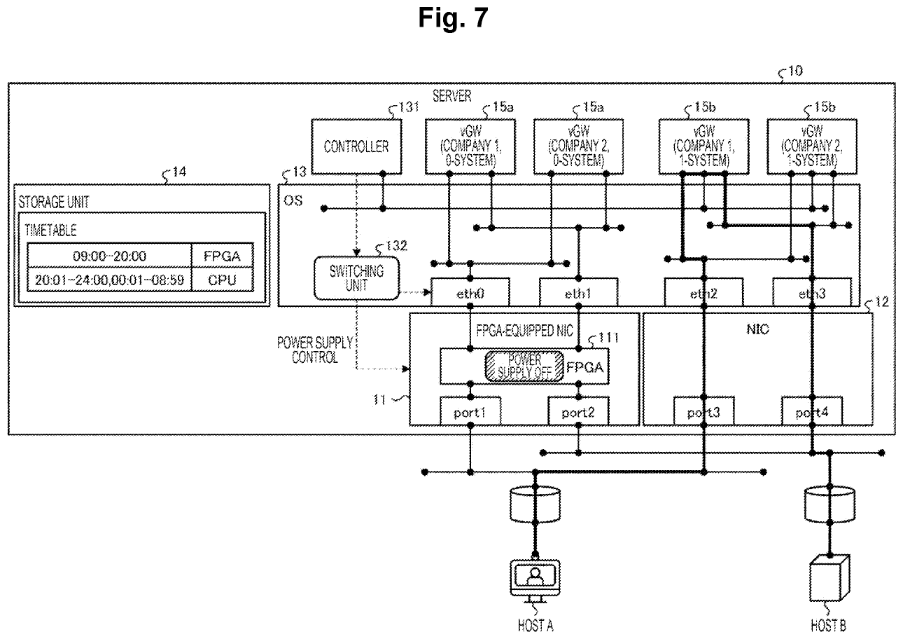

On the other hand, when the switching unit 132 receives an instruction indicating that the packet should be processed by the NIC 12, the power supply of the FPGA-equipped NIC 11 is turned off (see FIG. 7). Consequently, since the vGW 15 corresponding to the VIP becomes the vGW 15b, the packet destined for the VIP is input to the NIC 12 and processed by the vGW 15b (see a path represented by the thick line in FIG. 7). That is, the packet is processed by the CPU of the server 10. In addition, when the power supply of the FPGA-equipped NIC 11 is turned off, the power consumption of the server 10 is reduced.

As described above, the server 10 processes the packet by the FPGA 111 in a time period in which power efficiency is better when the packet is processed by the FPGA 111 (for example, a time period in which the traffic amount is large), and the server processes the packet by the CPU in a time period in which the power efficiency is better when the packet is processed by the CPU (for example, a time period in which the traffic amount is small). As a result, it is possible to enhance power efficiency of the server 10 while maintaining processing performance when the server 10 is under a high load.

In addition, in a case where an unexpected increase in traffic amount or an increase in the processing load occurs in the time period in which the processing is to be performed by the CPU, the server 10 can perform switching such that the packet processing is executed by the FPGA 111. Consequently, the server 10 can prevents a decrease in power efficiency and a decrease in communication quality from occurring even in a case where an unexpected increase in traffic amount or an unexpected increase in processing load occurs.

### Configuration Example

Returning to FIG. 4, a configuration example of the server 10 will be described. The server 10 includes the FPGA-equipped NIC 11, the normal NIC 12, an OS 13, the controller 131, the switching unit 132, a storage unit 14, and the redundant vGWs 15 (vGWs 15a and 15b).

The FPGA-equipped NIC 11 is an NIC equipped with the FPGA 111 that processes an input packet. The FPGA-equipped NIC 11 includes ports (for example, port1 and port2) that are charge in input and output of a packet. For example, when the FPGA-equipped NIC 11 accepts an input of a packet from port1, the FPGA 111 processes the packet and outputs the processed packet from port2. Of the redundant vGWs 15, the 0-system vGW 15a is connected to the FPGA-equipped NIC 11.

The NIC 12 is a normal NIC, and the 1-system vGW 15b of the redundant vGWs 15 is connected to the NIC 12. The NIC 12 includes ports (for example, port3 and port4) that are charge in input and output of a packet. For example, a packet accepted by the NIC 12 from port3 reaches the vGW 15b via an IF (for example, eth2) of the OS 13. Accordingly, the packet processed by the vGW 15b is output from port4 of the NIC 12 via an IF (for example, eth3) of the OS 13.

The OS 13 is basic software that operates the server 10. The OS 13 provides, for example, IFs (eth0 and eth1) that connect the FPGA-equipped NIC 11 and the vGW 15a, and IFs (eth2 and eth3) that connect the NIC 12 and the vGW 15b.

The controller 131 issues, to the switching unit 132, an instruction indicating which of the FPGA 111 and the CPU should process the packet. For example, the controller 131 determines which one of the FPGA 111 and the CPU should process the packet on the basis of the time period in which the packet is processed by the FPGA 111 and the time period in which the packet is processed by the CPU, which are set in the timetable, an operation state of each vGW 15b, and an operation state of the server 10, and issue an instruction to the switching unit 132.

Note that the operation state of each vGW 15b is measured by, for example, the amount of packets input to each vGW 15b, a usage rate of the CPU, and the like. For example, the controller 131 has reachability for each vGW 15b, and acquires the amount of packets input to each vGW 15b, a usage rate of the CPU, and the like.

The operation state of the server 10 is measured by, for example, power consumption of the server 10. The controller 131 acquires the power consumption of the server 10 by, for example, the Intelligent Platform Management Interface (IPMI) or the like.

For example, the controller 131 outputs an instruction indicating that the packet should be processed by the FPGA 111, to the switching unit 132, when the time period set in the timetable, in which the packet is processed by the FPGA 111, is reached. In addition, the controller 131 outputs an instruction indicating that the packet should be processed by the CPU, to the switching unit 132, when the time period set in the timetable, in which the packet is processed by the CPU, is reached.

However, in a case where the power consumption amount of the server 10 (the server equipped with the NIC 12) exceeds the predetermined threshold or in a case where the load of the packet processing in each vGW 15b exceeds the predetermined threshold, even in the time period set in the timetable in which the packet is to be processed by the CPU, the controller 131 issues, to the switching unit 132, an instruction indicating that the packet should be processed by the FPGA 111.

For example, the threshold of the power consumption amount described above is a value at which it is determined that the power efficiency is better when the packet is processed by the FPGA 111 than when the packet is processed by the CPU in a case where the power consumption of the server 10 exceeds the threshold. In addition, the threshold of the load of the packet processing is, for example, a value at which it is determined that the communication quality may be degraded in a case where the load of the packet processing in the vGW 15b exceeds the threshold.

The switching unit 132 executes switching between NICs on the basis of the instruction from the controller 131. For example, when the switching unit 132 receives, from the controller 131, the instruction indicating that the packet should be processed by the FPGA 111, the power supply of the FPGA-equipped NIC 11 is turned on. On the other hand, when the switching unit 132 receives, from the controller 131, an instruction indicating that the packet should be processed by the CPU, the power supply of the FPGA-equipped NIC 11 is turned off (see FIG. 7).

Note that the controller 131 and the switching unit 132 may be implemented by hardware or may be implemented by a program execution process.

The storage unit 14 stores data that is to be referred to when the server 10 executes various processes. For example, the storage unit 14 stores a timetable that is to be referred to by the controller 131. In the timetable, for example, as illustrated in FIG. 4, a time period in which the server 10 executes packet processing by the FPGA 111 and a time period in which the server 10 executes the packet processing by the CPU are set.

The time period set in the timetable in which the packet processing is executed by the FPGA 111 is a time period in which the power consumption is smaller when the packet processing is executed by the FPGA 111 than when the packet processing is executed by the CPU. The time period is, for example, a time period in which the traffic amount input to the server 10 is larger than a predetermined value, such as 9:00 to 20:00.

In addition, the time period set in the timetable in which the packet processing is executed by the CPU is a time period in which the power consumption is smaller when the packet processing is executed by the CPU than when the packet processing is executed by the FPGA-equipped NIC 11. The time period is, for example, a time period in which the traffic amount input to the server 10 is equal to or smaller than the predetermined value, such as a time period other than 9:00 to 20:00.

The time period in which the packet processing is executed by FPGA 111 and the time period in which the packet processing is executed by the CPU which are set in the timetable are determined by, for example, a measurement result of an input traffic amount to the server 10 for each time period. In addition, the time period set in the timetable can be appropriately changed by an administrator or the like.

The vGW 15 is a virtualized gateway and processes a packet input via the NIC. The VGW 15 has a redundancy configuration. For example, as illustrated in FIG. 4, in a case where the server 10 prepares the vGWs 15 for each of networks of Company 1 and Company 2, the 0-system vGW 15a and the 1-system vGW 15b are prepared for each of Company 1 and Company 2.

The 0-system vGW 15a is the vGW 15 that operates in a normal state. The 1-system vGW 15b is a vGW 15 that operates instead of the vGW 15a in a case where the vGW 15a becomes unable to communicate. The same virtual IP address is set to each of the vGW 15a and the vGW 15b. The vGW 15a and the vGW 15b are, for example, virtual routers that become redundancy by a virtual router redundancy protocol (VRRP), and the vGW 15a is operated as a master router by the VRRP. Of the vGW 15a and the vGW 15b, the vGW 15a is connected to the FPGA-equipped NIC 11, and the vGW 15b is connected to the NIC 12.

### [Example of Processing Procedure]

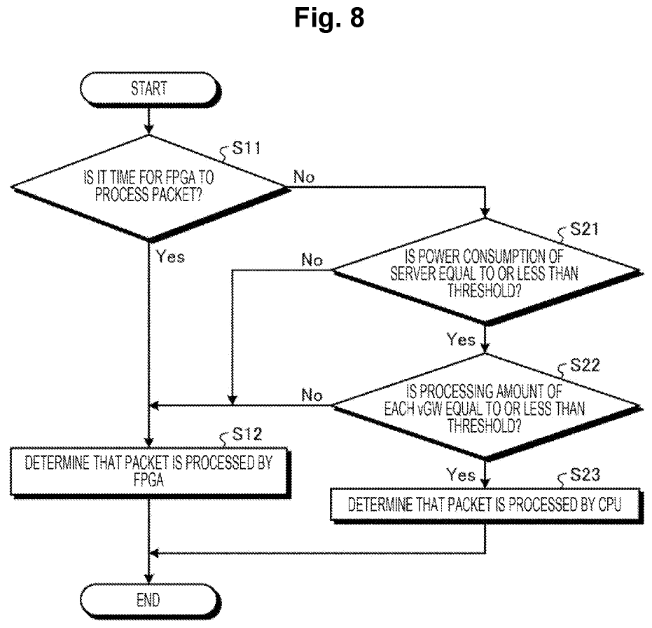

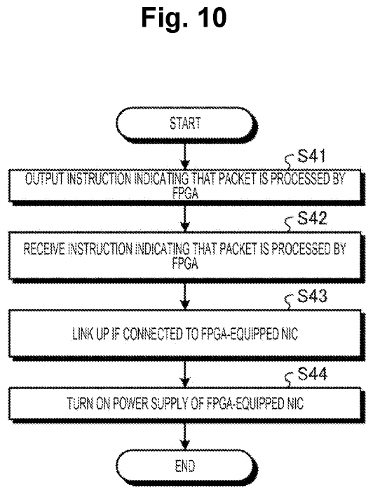

Next, an example of a processing procedure of the server 10 will be described with reference to FIGS. 8 and 10. First, a procedure in which the server 10 determines which of the FPGA 111 and the CPU should process a packet will be described with reference to FIG. 8.

For example, when the controller 131 of the server 10 refers to the timetable and determines that a current time point is the time when the FPGA processes the packet (Yes in S11), it is determined that the packet is processed by the FPGA 111 (S12). On the other hand, the controller 131 refers to the timetable, determines that the current time is not the time when the FPGA processes the packet (No in S11), and determines that the packet is processed by the CPU (S23), in a case where the power consumption of the server 10 is equal to or smaller than the threshold (Yes in S21), and the processing amount of each vGW 15b is equal to or smaller than the threshold (Yes in S22).

In addition, in a case where the controller 131 refers to the timetable and determines that the current time point is not the time for the FPGA to process the packet (No in S11), but the power consumption of the server 10 exceeds the threshold (No in S21), the controller 131 determines that the packet is processed by FPGA 111 (S12). As a result, the server 10 can prevent the power efficiency from deteriorating.

In addition, in a case where the power consumption of the server 10 is equal to or less than the threshold (Yes in S21), but the processing amount of each vGW 15b exceeds the threshold (No in S22), the controller also determines that the packet is to be processed by the FPGA 111 (S12). Consequently, in a case where there is a possibility that the communication quality can deteriorate even if the power efficiency is better when the packet is processed by the CPU as it is, the server 10 can prevent the deterioration in advance.

Next, an example of a processing procedure in a case where the server 10 performs switching such that the packet processing performed by the FPGA 111 is performed by the CPU on the basis of the above determination, and an example of a processing procedure in a case where the server 10 performs switching such that the packet processing performed by the CPU is performed by the FPGA 111 will be described.

### [Switching Method (FPGA→CPU)]

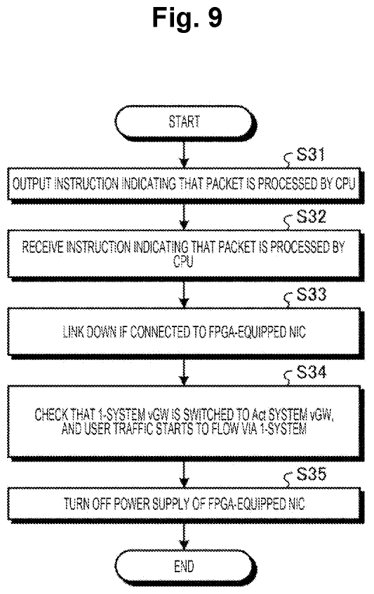

An example of a processing procedure in a case where the server 10 performs switching from the FPGA 111 to the CPU by which the packet processing is performed will be described with reference to FIG. 9, as well as to FIGS. 4 and 7.

When the controller 131 determines to perform switching from the FPGA 111 to the CPU by which the packet processing is performed, the controller 131 of the server 10 outputs, to the switching unit 132, an instruction indicating that the packet is processed by the CPU (S31). After S31, when the switching unit 132 receives the instruction indicating that the packet is processed by the CPU (S32), the switching unit 132 links down the IF (for example, eth0) connected to the FPGA-equipped NIC 11, among the IFs provided by the OS 13 (S33).

After S33, the switching unit 132 checks that the 1-system vGW 15b is switched to an ACT-system vGW 15 and the user traffic starts flowing via the vGW 15b (S34). For example, the switching unit 132 checks that the user traffic starts flowing via the vGW 15b, on the basis of the traffic amount flowing through the IF (for example, eth2 illustrated in FIG. 4) connected to the vGW 15b. Thereafter, the switching unit 132 turns off the power supply of the FPGA-equipped NIC 11 (S35).

Consequently, for example, as illustrated in FIG. 7, the user traffic is input from the NIC 12 of the server 10, reaches the vGW 15b, is processed by the vGW 15b, and then is output via the NIC 12.

Note that the reason why the switching unit 132 turns off the power supply of the FPGA-equipped NIC 11 after linking down the IF connected to the FPGA-equipped NIC 11 is that the user traffic flows via the FPGA-equipped NIC 11 even in a standby time until the ACT-system vGW 15 is switched from the vGW 15a to the vGW 15b. Consequently, communication interruption of the user traffic does not occur.

### [Switching Method (CPU-FPGA)]

An example of a processing procedure when the server 10 performs switching from the CPU to the FPGA 111 by which the packet processing is performed will be described with reference to FIG. 10, as well as FIG. 4.

When the controller 131 determines to perform switching from the CPU to the FPGA 111 by which the packet processing is performed, the controller 131 of the server 10 outputs, to the switching unit 132, an instruction indicating that the packet is processed by the FPGA 111 (S41).

After S41, when the switching unit 132 receives the instruction indicating that the packet is processed by the FPGA 111 (S42), the switching unit 132 links up the IF (for example, eth0 illustrated in FIG. 4) connected to the FPGA-equipped NIC 11, among the IFs provided by the OS 13 (S43), and turns on the power supply of the FPGA-equipped NIC 11 (S44). Consequently, the ACT-system vGW 15 is switched from the 1-system vGW 15b to the 0-system vGW 15a, and the user traffic starts flowing via the FPGA-equipped NIC 11. Note that the switching unit 132 may link up the IF connected to the FPGA-equipped NIC 11 after turning on the power supply of the FPGA-equipped NIC 11.

### [Details of FPGA]

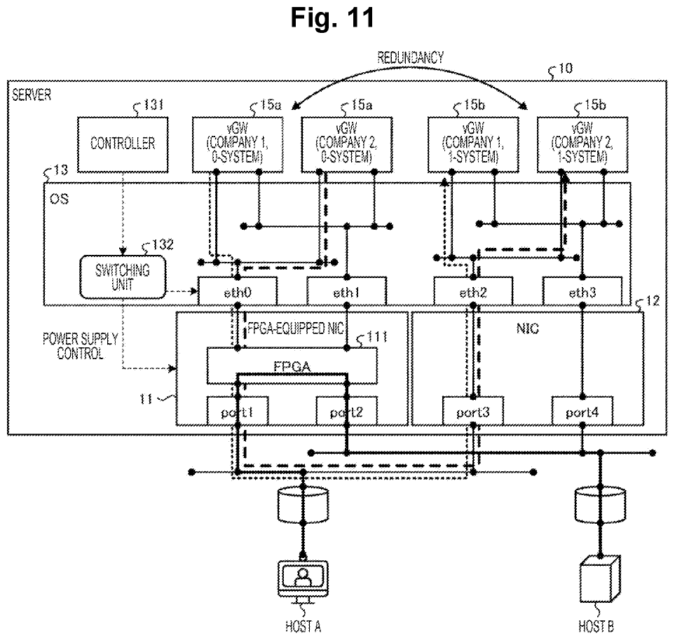

Next, the FPGA 111 will be described in detail with reference to FIG. 11. Here, a case where, in a time period in which the server 10 executes the packet processing by the FPGA 111, user traffic flows along a path represented by a solid line in FIG. 11, and a power-on/off monitoring packet of the 0-system vGW 15a and the 1-system vGW 15b flows along a path represented by a broken line in FIG. 11 will be described as an example.

In this case, the FPGA 111 outputs a packet with Dst IP=0-system vGW 15a to eth0 of the OS 13. In addition, the FPGA 111 outputs a packet with Dst IP=1-system vGW 15b to the opposite port1. Further, in a case where Dst IP is other than the vGWs 15a and 15b, the FPGA 111 outputs a packet to a port opposite to an input port (for example, port2, in a case where the input port is port1).

In this manner, the FPGA 111 can distinguish the power-on/off monitoring packet between the vGWs 15a and 15b from the packet between hosts A and B and can appropriately perform path control for each packet.

Note that, in the case of the time period in which the server 10 executes the packet processing by the CPU (that is, vGW 15b), for example, the user traffic flows through the path illustrated in FIG. 7. In addition, since the FPGA-equipped NIC 11 is powered off in the time period, the power-on/off monitoring packet does not flow between the 0-system vGW 15a and the 1-system vGW 15b.

As described above, the server 10 processes the packet by the FPGA 111 in a time period in which power efficiency is better when the packet is processed by the FPGA 111 (for example, a time period in which the traffic amount is large), and the server processes the packet by the CPU in a time period in which the power efficiency is better when the packet is processed by the CPU (for example, a time period in which the traffic amount is small). As a result, it is possible to enhance power efficiency of the server 10 while maintaining processing performance when the server 10 is under a high load.

In addition, in a case where an unexpected increase in traffic amount or an increase in the processing load occurs in the time period in which the processing is to be performed by the CPU, the server 10 can perform switching such that the packet processing is executed by the FPGA 111. Consequently, the server 10 can prevents a decrease in power efficiency and a decrease in communication quality from occurring even in a case where an unexpected increase in traffic amount or an unexpected increase in processing load occurs.

In the above-described embodiments, the case where the vGWs 15 connected to the FPGA-equipped NIC 11 and the NIC 12 are respectively separate vGWs 15 has been described as an example, but the present invention is not limited thereto. For example, both the FPGA-equipped NIC 11 and the NIC 12 may be connected to the same vGW 15.

In addition, in the above-described embodiments, the case where the FPGA-equipped NIC and the NIC 12 (and the vGW connected to each NIC) are mounted on the same server (server 10) has been described, but the FPGA-equipped NIC 11 and the NIC 12 may be mounted on separate servers, respectively. In this case, for example, in a case where the switching unit 132 turns off the power supply of the FPGA-equipped NIC 11, the switching unit turns off a power supply of the server on which the FPGA-equipped NIC 11 is mounted. In addition, in a case where the power supply of the FPGA-equipped NIC 11 is turned on, the switching unit 132 turns on the power supply of the server on which the FPGA-equipped NIC 11 is mounted.

### [System Configuration and Others]

In addition, each component of each unit illustrated in the drawings is functionally conceptual and does not necessarily have to be physically configured as illustrated in the drawings. That is, specific forms of distribution and integration of devices are not limited to the illustrated forms, and some or all of the devices can be functionally or physically distributed and integrated in any units according to various loads, usage conditions, and the like. Further, all or any part of each processing function performed in each device can be implemented by a CPU and a program executed by the CPU, or can be implemented as hardware by wired logic.

In addition, among the processing described in the above-described embodiment, all or a part of processing described as being automatically performed may be manually performed, or all or a part of processing described as being manually performed may be automatically performed by a known method. Further, the processing procedures, the control procedures, the specific names, and the information including various kinds of data and parameters in the above document and drawings can be arbitrarily changed unless otherwise specified.

### [Program]

The controller 131 and the switching unit 132 described above can be implemented by installing a program (switching program) as package software or online software in a desired computer. For example, an information processing device is caused to execute the above program, and thereby the information processing device can be caused to function as the controller 131 and the switching unit 132. Here, the information processing device also includes mobile communication terminals such as a smartphone, a mobile phone, and a personal handyphone system (PHS) and terminals such as a personal digital assistant (PDA).

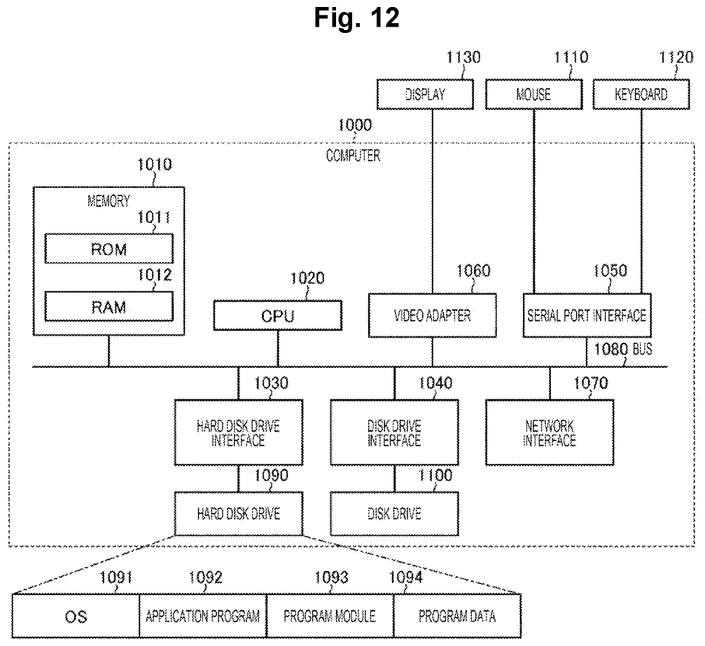

FIG. 12 is a diagram illustrating an example of a computer that executes the switching program. The computer 1000 includes a memory 1010 and a CPU 1020, for example. The computer 1000 also includes a hard disk drive interface 1030, a disk drive interface 1040, a serial port interface 1050, a video adapter 1060, and a network interface 1070. These units are connected to each other by a bus 1080.

The memory 1010 includes read only memory (ROM) 1011 and random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to a mouse 1110 and a keyboard 1120, for example. The video adapter 1060 is connected to, for example, a display 1130.

The hard disk drive 1090 stores, for example, an OS 1091, an application program 1092, a program module 1093, and program data 1094. That is, a program that defines each piece of processing executed by the controller 131 and the switching unit 132 described above is implemented as the program module 1093 in which a code executable by the computer is written. The program module 1093 is stored in, for example, the hard disk drive 1090. For example, the program module 1093 for executing processing similar to the functional configuration in the controller 131 and the switching unit 132 is stored in the hard disk drive 1090. Note that the hard disk drive 1090 may be replaced with a solid state drive (SSD).

In addition, data used in the processing of the above-described embodiment is stored, for example, in the memory 1010 or the hard disk drive 1090 as the program data 1094. In addition, the CPU 1020 reads the program module 1093 and the program data 1094 stored in the memory 1010 or the hard disk drive 1090 into the RAM 1012 as necessary and executes the program module 1093 and the program data 1094.

Note that the program module 1093 and the program data 1094 are not limited to being stored in the hard disk drive 1090 and may be stored in, for example, a removable storage medium and be read by the CPU 1020 via the disk drive 1100 or the like. Alternatively, the program module 1093 and the program data 1094 may be stored in another computer connected via a network (local area network (LAN), wide area network (WAN), or the like). In addition, the program module 1093 and the program data 1094 may be read by the CPU 1020 from another computer via the network interface 1070.

### REFERENCE SIGNS LIST

10 Server
11 FPGA-equipped NIC (first NIC)
12 NIC (second NIC)
13 OS
14 Storage unit
15(15a, 15b) vGW
131 Controller
132 Switching unit

1. A communication system comprising:
a first network interface card (NIC) that is connected to a virtual machine and is equipped with a field programmable gate array (FPGA) which processes an input packet destined for the virtual machine;
a second NIC to which the same IP address as an IP address of the virtual machine is set and which is connected to a virtual machine that processes an input packet; and
a switching unit that switches an NIC that accepts the input packet; and
a controller that instructs the switching unit to switch an NIC that accepts the packet to the first NIC when a predetermined time period in which the FPGA processes a packet is reached and when a power consumption amount of a device equipped with the second NIC exceeds a predetermined threshold or when a load of packet processing in a virtual machine connected to the second NIC exceeds a predetermined threshold, in a time period in which the virtual machine processes a packet.

2. The communication system according to claim 1, wherein
the controller
instructs the switching unit to switch an NIC that accepts the packet to the second NIC when a predetermined time period in which the virtual machine processes a packet is reached, and
the switching unit
switches an NIC that accepts the packet to the second NIC by turning off a power supply of the first NIC or turning off a device equipped with the first NIC.

3. The communication system according to claim 1, wherein
the switching unit
switches an NIC that accepts the packet to the first NIC by turning on a power supply of the first NIC or turning on a device equipped with the first NIC.

4. The communication system according to claim 1, wherein
a virtual machine connected to the first NIC and a virtual machine connected to the second NIC are virtual routers made redundant by Virtual Router Redundancy Protocol (VRRP), and the virtual machine connected to the first NIC is a master router of the VRRP.

5. The communication system according to claim 1, wherein
the controller
acquires a power consumption amount of a server equipped with the second NIC and a processing load in a virtual machine connected to the second NIC.

6. A switching method executed by a communication system, wherein
the communication system including a first NIC that is connected to a virtual machine and is equipped with a field programmable gate array (FPGA) which processes an input packet destined for the virtual machine, a second NIC to which the same IP address as an IP address of the virtual machine is set and which is connected to a virtual machine that processes an input packet, and a switching unit that switches an NIC that accepts the input packet, comprises
instructing the switching unit to switch an NIC that accepts the packet to the first NIC when a predetermined time period in which the FPGA processes a packet is reached and when a power consumption amount of a device equipped with the second NIC exceeds a predetermined threshold or when a load of packet processing in a virtual machine connected to the second NIC exceeds a predetermined threshold, in a time period in which the virtual machine processes a packet.

7. A computer-readable non-transitory recording medium storing computer-executable program instructions that when executed by a processor cause a computer to execute switching program for causing a computer, in a communication system including a first NIC that is connected to a virtual machine and is equipped with a field programmable gate array (FPGA) which processes an input packet destined for the virtual machine, a second NIC to which the same IP address as an IP address of the virtual machine is set and which is connected to a virtual machine that processes an input packet, and a switching unit that switches an NIC that accepts the input packet, to execute:
instructing the switching unit to switch an NIC that accepts the packet to the first NIC when a predetermined time period in which the FPGA processes a packet is reached and in a case where a power consumption amount of a device equipped with the second NIC exceeds a predetermined threshold or a case where a load of packet processing in a virtual machine connected to the second NIC exceeds a predetermined threshold, in a time period in which the virtual machine processes a packet.

8. The switching method according to claim 6, further comprising:
switching an NIC that accepts the packet to the second NIC when a predetermined time period in which the virtual machine processes a packet is reached, and
switches an NIC that accepts the packet to the second NIC by turning off a power supply of the first NIC or turning off a device equipped with the first NIC.

9. The switching method according to claim 6, further comprising:
accepting the packet to the first NIC by turning on a power supply of the first NIC or turning on a device equipped with the first NIC.

10. The switching method according to claim 6, further comprising:
connecting to the first NIC and a virtual machine connected to the second NIC are virtual routers made redundant by Virtual Router Redundancy Protocol (VRRP), and the virtual machine connected to the first NIC is a master router of the VRRP.

11. The switching method according to claim 6, further comprising:
acquiring a power consumption amount of a server equipped with the second NIC and a processing load in a virtual machine connected to the second NIC.

12. The computer-readable non-transitory recording medium according to claim 7 wherein the switching program further comprises:
switching an NIC that accepts the packet to the second NIC when a predetermined time period in which the virtual machine processes a packet is reached, and
switching an NIC that accepts the packet to the second NIC by turning off a power supply of the first NIC or turning off a device equipped with the first NIC.

13. The computer-readable non-transitory recording medium according to claim 7 wherein the switching program further comprises:
accepting the packet to the first NIC by turning on a power supply of the first NIC or turning on a device equipped with the first NIC.

14. The computer-readable non-transitory recording medium according to claim 7 wherein the switching program further comprises:
connecting to the first NIC and a virtual machine connected to the second NIC are virtual routers made redundant by Virtual Router Redundancy Protocol (VRRP), and the virtual machine connected to the first NIC is a master router of the VRRP.

15. The computer-readable non-transitory recording medium according to claim 7 wherein the switching program further comprises:
acquiring a power consumption amount of a server equipped with the second NIC and a processing load in a virtual machine connected to the second NIC.
